(19) United States
(12) Patent Application Publication
(10) Pub. No.: US 2022/0293324 A1
(43) Pub. Date: Sep. 15, 2022

(54) COIL COMPONENT

(71) Applicant: TDK CORPORATION, Tokyo (JP)

(72) Inventors: Hajime KATO, Tokyo (JP); Junichiro URABE, Tokyo (JP); Toshinori MATSUURA, Tokyo (JP); Kazuya TOBITA, Tokyo (JP); Yuto SHIGA, Tokyo (JP); Yuichi TAKUBO, Tokyo (JP); Youichi KAZUTA, Tokyo (JP); Noriaki HAMACHI, Tokyo (JP)

(73) Assignee: TDK CORPORATION, Tokyo (JP)

(21) Appl. No.: 17/682,552

(22) Filed: Feb. 28, 2022

(30) Foreign Application Priority Data
Mar. 11, 2021 (JP) 2021-039370

(51) Int. Cl. H01F 27/02; H01F 27/29

(52) U.S. Cl. CPC H01F 27/022; H01F 27/292

(57) ABSTRACT

In a coil component, a coil is disposed in the element body and has a pair of tip portions. A pair of external electrodes are disposed on an outer surface of the element body and respectively connected to the pair of tip portions. The element body includes a core portion including a shaft portion and a pair of side end portions. The shaft portion extends in a first direction, and the coil is wound around the shaft portion. The pair of side end portions are continuous with both ends of the shaft portion in the first direction. The shaft portion and the pair of side end portions are integrally formed of the same material. The shaft portion is covered with a resin molding portion. At least a part of the pair of side end portions is exposed from the resin molding portion.

### TECHNICAL FIELD

The present invention relates to a coil component.

### BACKGROUND

Known is a coil component in which a coil is disposed in an element body (for example, Japanese Unexamined Patent Publication No. 2015-70154). For example, the coil is wound around a core portion. The core portion and the coil are covered with a resin molding portion. An external electrode connected to the coil is disposed on an outer surface of the element body.

The coil component is used in various temperature environments. Accordingly, the element body may be deformed due to thermal expansion or thermal contraction. For example, in a case where the coefficient of thermal expansion of the core portion and the coefficient of thermal expansion of the resin molding portion covering the core portion are different from each other, stress is generated due to the difference in the coefficient of thermal expansion between the core portion and the resin molding portion. As a result, the outer surface of the element body may be distorted due to a change in temperature. In the event of a distortion of the outer surface of the element body, the distortion may lead to misalignment of the external electrode disposed on the outer surface of the element body. The misalignment of the external electrode affects the state of connection between the coil and the external electrode.

### SUMMARY

An object of one aspect of the present invention is to provide a coil component capable of suppressing element body distortion in response to a change in temperature.

A coil component in one aspect of the present invention includes an element body, a coil, and a pair of external electrodes. The coil is disposed in the element body and has a pair of tip portions. The pair of external electrodes are disposed on an outer surface of the element body and respectively connected to the pair of tip portions. The element body includes a core portion and a resin molding portion. The coil is wound around the core portion. The resin molding portion covers at least a part of the core portion and covers at least a part of the coil. The core portion includes a shaft portion and a pair of side end portions. The shaft portion extends in a first direction, and the coil is wound around the shaft portion. The pair of side end portions are continuous with both ends of the shaft portion in the first direction. The shaft portion and the pair of side end portions are integrally formed of the same material. The shaft portion is covered with the resin molding portion. At least a part of the pair of side end portions is exposed from the resin molding portion.

In this coil component, the core portion includes the pair of side end portions and the shaft portion which are integrally formed of the same material. The pair of side end portions are continuous with both ends of the shaft portion in the direction in which the shaft portion extends. At least a part of the pair of side end portions is exposed from the resin molding portion. In this case, even if the core portion thermally expands, the element body is unlikely to be distorted because the pair of side end portions are exposed from the resin molding portion. Accordingly, a distortion of the element body in response to a change in temperature can be suppressed.

In the above aspect, the pair of side end portions may include an exposed portion. The exposed portion may be exposed from the resin molding portion. The shaft portion may be positioned in a region where the exposed portion is positioned when viewed from the first direction. A projection area of the exposed portion in the first direction may be larger than a projection area of the shaft portion in the first direction. In this case, since the area of the exposed portion in the core portion is relatively large, the distortion of the element body in response to the temperature change can be further suppressed.

In the above aspect, the pair of side end portions may form a step with respect to the shaft portion. In this case, the position of the coil in the first direction is regulated by the step. Accordingly, with this structure, variations between products can be reduced and an improvement in production throughput can be achieved.

In the above aspect, the pair of side end portions may include an exposed surface. The exposed surface may be exposed from the resin molding portion. The exposed surface may be surrounded by a surface formed by the resin molding portion when viewed from the first direction. In this case, the position of the shaft portion around which the coil is wound can be easily grasped from the position of the exposed surface. Accordingly, with this structure, visual inspection is facilitated and manufacturing cost reduction can be achieved.

In the above aspect, the shaft portion may include a first side surface extending in the first direction. Each of the pair of side end portions may include a second side surface extending in the first direction. The first side surface and the second side surface of each of the side end portions may be flush with each other in the first direction. In this case, the position of the shaft portion around which the coil is wound can be easily grasped from the position of the exposed portion. Accordingly, with this structure, visual inspection is facilitated and manufacturing cost reduction can be achieved.

In the above aspect, the core portion may be formed of resin. In this case, the dielectric constant of the shaft portion can be reduced as compared with a case where the shaft portion is formed of ceramic. Accordingly, this coil component is capable of adapting to a higher frequency.

In the above aspect, the element body may have at least one flat surface along the first direction. The pair of external electrodes may be disposed on the resin molding portion on the same flat surface.

In the above aspect, the resin molding portion and the core portion may be formed of mutually different materials. In this case, the dielectric constant of the core portion can be reduced as compared with a case where the core portion is formed of a ceramic material.

An object of one aspect of the present invention is to provide a coil component capable of suppressing element body distortion in response to a change in temperature.

### BRIEF DESCRIPTION OF THE DRAWINGS

FIG. 1 is a perspective view of a coil component according to the present embodiment.

FIG. 2 is a perspective view illustrating the inner portion of the coil component.

FIG. 3 is a perspective view of a coil component according to a modification example of the present embodiment.

FIG. 4 is a perspective view illustrating the inner portion of the coil component according to the modification example of the present embodiment.

### DETAILED DESCRIPTION

Hereinafter, an embodiment of the present invention will be described in detail with reference to the accompanying drawings. In the description of the drawings, the same reference numerals are used for the same or equivalent elements with redundant description omitted.

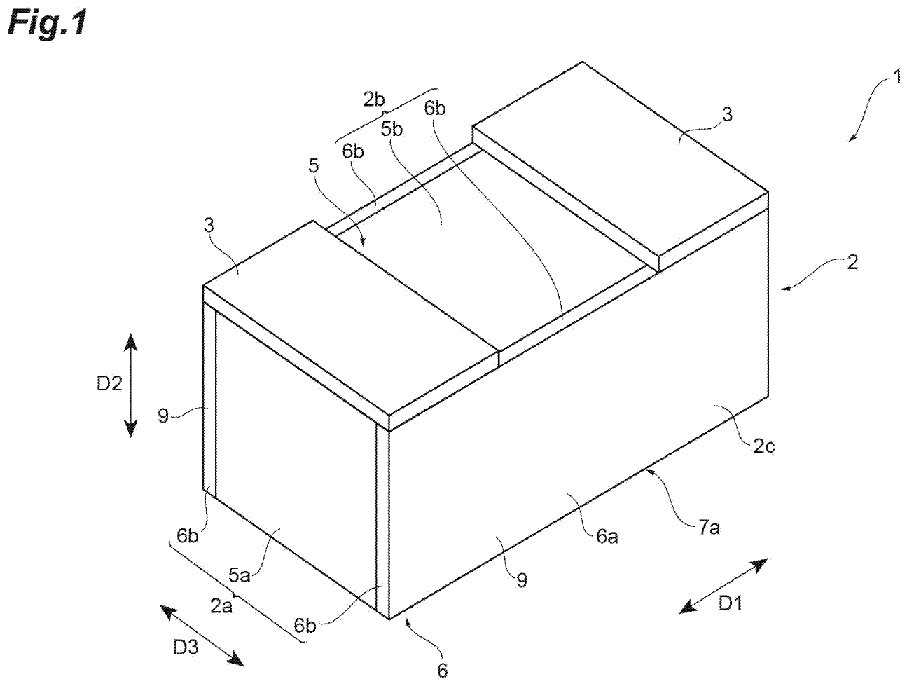

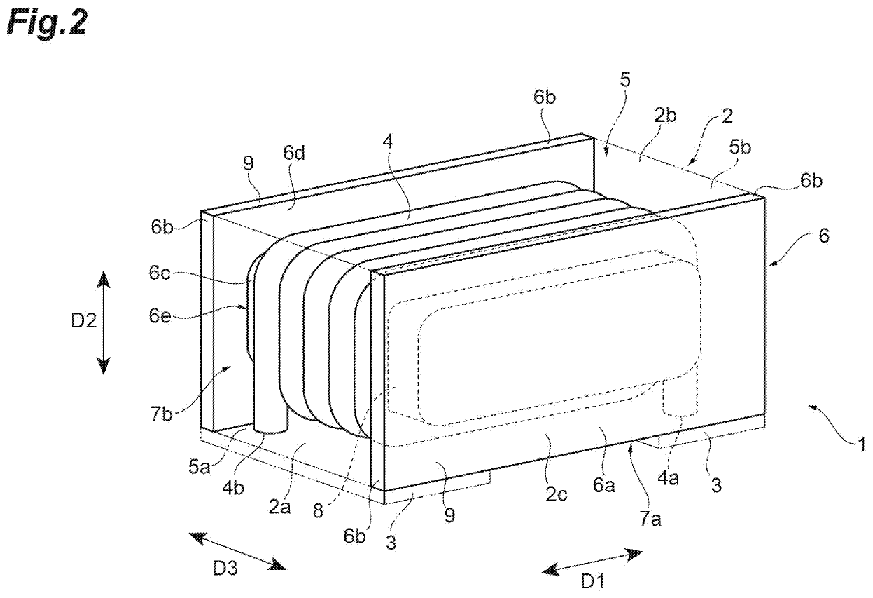

First, a coil component in the present embodiment will be described with reference to FIGS. 1 and 2. FIG. 1 is a perspective view of the coil component according to the present embodiment. FIG. 2 is a perspective view illustrating the inner portion of the coil component. A coil component 1 includes an element body 2, a pair of external electrodes 3, and a coil 4. The pair of external electrodes 3 are disposed on an outer surface of the element body 2 and connected to the coil 4. As illustrated in FIG. 2, the coil 4 is disposed in the element body 2.

The element body 2 has a pair of end surfaces 2a, a pair of side surfaces 2b, and a pair of side surfaces 2c as outer surfaces. The pair of end surfaces 2a face each other in a longitudinal direction D1. The pair of side surfaces 2b face each other in a height direction D2. The pair of side surfaces 2c face each other in a width direction D3. The pair of end surfaces 2a and the pair of side surfaces 2b are along the width direction D3. The element body 2 has at least one flat surface. For example, the pair of end surfaces 2a, the pair of side surfaces 2b, and the pair of side surfaces 2c are each a flat surface.

In the present embodiment, the element body 2 has a rectangular parallelepiped shape in which the length in the height direction D2 is smaller than the length in the longitudinal direction D1 and the length in the width direction D3 is smaller than the length in the height direction D2. The rectangular parallelepiped shape includes a rectangular parallelepiped shape having chamfered corner and ridge portions and a rectangular parallelepiped shape having rounded corner and ridge portions. The element body 2 is formed of, for example, resin. As a modification example of the present embodiment, the element body 2 may have a rectangular parallelepiped shape in which the length in the Z-axis direction is smaller than the length in the Y-axis direction and the length in the X-axis direction is smaller than the length in the Z-axis direction.

The pair of external electrodes 3 are disposed on the same flat surface. For example, the pair of external electrodes 3 are disposed on the same side surface 2b. The pair of external electrodes 3 are, for example, disposed at both ends of the side surface 2b of the element body 2 in the longitudinal direction D1. The pair of external electrodes 3 are separated from each other and face each other in the longitudinal direction D1. Each external electrode 3 has, for example, a rectangular shape in a plan view. Each external electrode 3 includes, for example, a resin electrode. Each external electrode 3 may be configured by, for example, only a resin electrode. Each external electrode 3 is formed by a known technique. For example, each external electrode 3 is formed by electrode paste being applied to the element body 2 and then dried. The electrode paste is applied to the element body 2 by, for example, a screen printing method. Each external electrode 3 is plated.

The coil 4 has a pair of tip portions 4a and 4b. The pair of tip portions 4a and 4b are respectively connected to the different external electrodes 3. The pair of tip portions 4a and 4b are, for example, exposed from a resin molding portion 5 on one side surface 2b of the element body 2 and connected to the corresponding external electrodes 3.

Next, the configuration of the coil component 1 will be described in detail with reference to FIGS. 1 and 2. The element body 2 includes the resin molding portion 5 and a core portion 6. In FIG. 2, the resin molding portion 5 is indicated by a two-dot chain line.

The resin molding portion 5 covers at least a part of the coil 4. The resin molding portion 5 covers at least a part of the core portion 6. In the present specification, “covering” means surrounding an object to be covered such that the object cannot be seen. “Covering” includes not only being in direct contact with the object but also being separated from the object. For example, the resin molding portion 5 may cover the object from above another member or there may be a part where the object and the resin molding portion 5 are not in contact with each other. For example, the core portion 6 may have a part covered with the resin molding portion 5 from above the coil 4 without the resin molding portion 5 and the core portion 6 being in direct contact with each other. The coil 4 is, for example, covered with the resin molding portion 5 except for the pair of tip portions 4a and 4b.

The resin molding portion 5 has a pair of end surfaces 5a and a pair of side surfaces 5b. The pair of end surfaces 5a face each other in the longitudinal direction D1. The pair of side surfaces 5b face each other in the height direction D2. The pair of end surfaces 5a form a part of the pair of end surfaces 2a. The pair of side surfaces 5b form a part of the pair of side surfaces 2b. The pair of tip portions 4a and 4b of the coil 4 are exposed from, for example, the side surface 5b of the resin molding portion 5. The pair of external electrodes 3 are disposed on at least the resin molding portion 5 on the same side surface 5b. The pair of external electrodes 3 are disposed on, for example, the same side surface 5b.

The coil 4 is wound around the core portion 6. The core portion 6 is partially covered with the resin molding portion 5. The core portion 6 includes an exposed portion 7a exposed from the resin molding portion 5 and a non-exposed portion 7b covered with the resin molding portion 5. In the present embodiment, the exposed portion 7a includes a wall surface 6a and a side surface 6b. The wall surface 6a intersects the width direction D3. The wall surface 6a forms the side surface 2c. The side surface 6b is along the width direction D3. The side surface 6b forms a part of the end surface 2a and the side surface 2b.

The non-exposed portion 7b includes a side surface 6c and a wall surface 6d. The side surface 6c extends in the width direction D3. The coil 4 is wound around the side surface 6c. The wall surface 6d is along a direction intersecting the width direction D3.

For example, the wall surface 6a of the exposed portion 7a and the wall surface 6d of the non-exposed portion 7b are parallel to each other. The core portion 6 includes a step portion 6e. The step portion 6e is formed by the side surface 6c and the wall surface 6d of the non-exposed portion 7b.

In the present embodiment, the wall surface 6a of the exposed portion 7a is connected to the side surface 6b of the exposed portion 7a. The side surface 6b of the exposed portion 7a is connected to the wall surface 6d of the non-exposed portion 7b. The wall surface 6d of the non-exposed portion 7b is connected to the side surface 6c of the non-exposed portion 7b.

The core portion 6 includes a shaft portion 8 and a pair of side end portions 9. The shaft portion 8 and the pair of side end portions 9 are integrally formed of, for example, the same material. The shaft portion 8 is covered with the resin molding portion 5. For example, the shaft portion 8 may be covered with the resin molding portion 5 from above the coil 4 and there may be a part where the resin molding portion 5 and the shaft portion 8 are not in direct contact with each other. At least a part of the pair of side end portions 9 is exposed from the resin molding portion 5.

The coefficient of thermal expansion of the core portion 6 and the coefficient of thermal expansion of the resin molding portion 5 are different from each other. The core portion 6 and the resin molding portion 5 are formed of, for example, mutually different materials. The coefficient of thermal expansion of the material of the core portion 6 and the coefficient of thermal expansion of the material of the resin molding portion 5 are, for example, different from each other. The core portion 6 is formed of, for example, resin. In other words, the core portion 6 contains, for example, resin. The core portion 6 may be made of, for example, only resin. The material of the core portion 6 contains, for example, at least one selected from a liquid crystal polymer, a polyimide resin, crystalline polystyrene, an epoxy resin, and a fluorine-based resin. The material of the resin molding portion 5 contains, for example, at least one selected from a liquid crystal polymer, a polyimide resin, crystalline polystyrene, an epoxy resin, and a fluorine-based resin. The polyimide resin is, for example, a bismaleimide resin. The fluororesin is, for example, a polytetrafluoroethylene (PTFE) resin.

The shaft portion 8 extends in the width direction D3. The shaft portion 8 includes a part of the non-exposed portion 7b. The shaft portion 8 has a pillar shape extending in the width direction D3. The coil 4 is wound around the shaft portion 8. The coil 4 is wound around the shaft portion 8 in the circumferential direction of the shaft portion 8. The coil 4 is spirally wound around the shaft portion 8 as an axis. The axis of rotation of the coil 4 is along the width direction D3. In other words, the axis of rotation of the coil 4 extends in the width direction D3. The axis of rotation of the coil 4 is along the axis of the shaft portion 8.

The pair of side end portions 9 are continuous with both ends of the shaft portion 8 in the width direction D3. In the present specification, “being continuous” means being in direct contact. For example, each side end portion 9 is in direct contact with an end of the shaft portion 8. The pair of side end portions 9 include the exposed portion 7a and a part of the non-exposed portion 7b. The exposed portion 7a is formed by each side end portion 9. In the present embodiment, the projection area of the exposed portion 7a in the width direction D3 is larger than the projection area of the shaft portion 8 in the width direction D3. When viewed from the width direction D3, the shaft portion 8 is positioned in the region where the exposed portion 7a is positioned.

In the present embodiment, the shaft portion 8 includes the side surface 6c of the non-exposed portion 7b. The pair of side end portions 9 include the wall surface 6a and the side surface 6b of the exposed portion 7a and the wall surface 6d of the non-exposed portion 7b. The pair of side end portions 9 form a step with respect to the shaft portion 8. The step portion 6e is formed by the shaft portion 8 and the side end portion 9.

In the present embodiment, the end surface 5a of the resin molding portion 5 and the side surface 6b of the pair of side end portions 9 are flush with each other. In other words, each end surface 2a of the element body 2 is formed flat by the pair of side end portions 9 and the resin molding portion 5. The side surface 5b of the resin molding portion 5 and the side surface 6b of the pair of side end portions 9 are flush with each other. In other words, each side surface 2b of the element body 2 is formed flat by the pair of side end portions 9 and the resin molding portion 5.

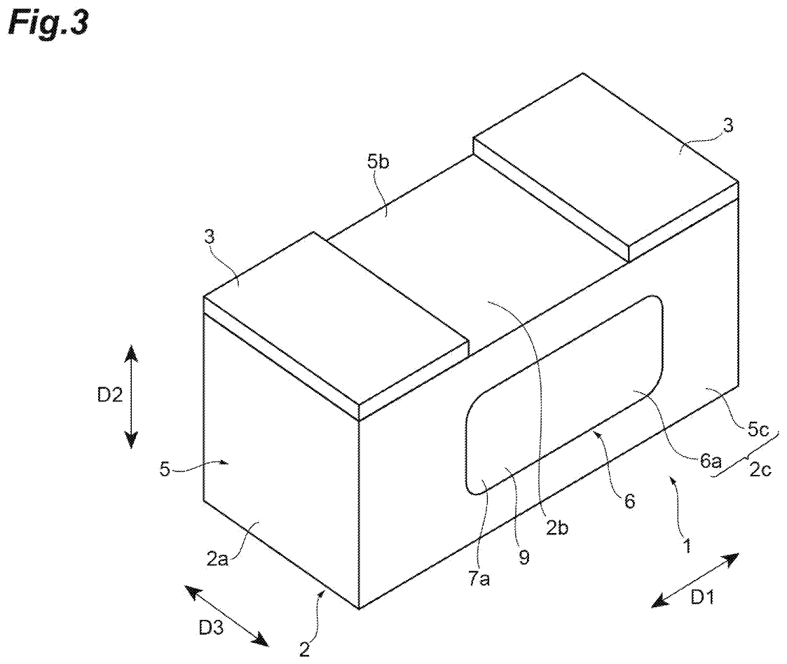

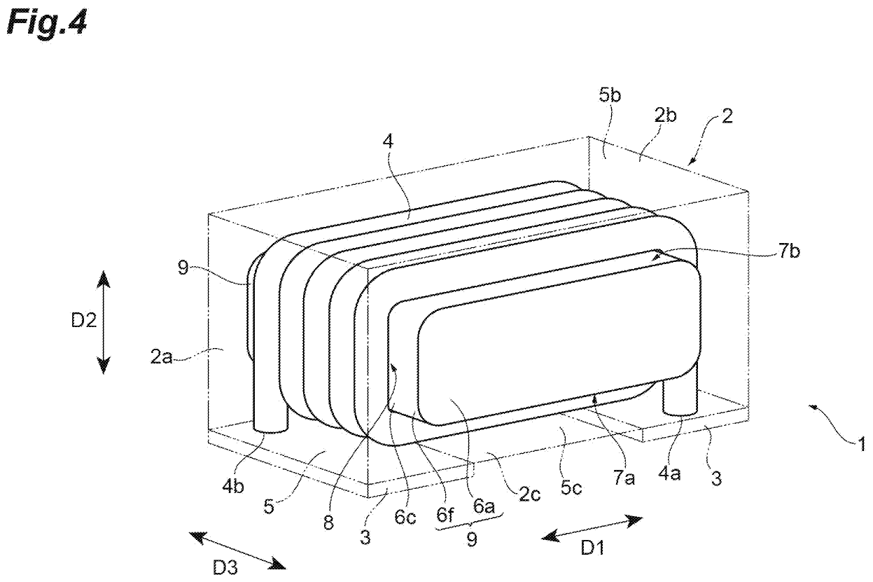

Next, a coil component in a modification example of the present embodiment will be described with reference to FIGS. 3 and 4. FIG. 3 is a perspective view of the coil component in this modification example. FIG. 4 is a perspective view illustrating the inner portion of the coil component in this modification example. In FIG. 4, the resin molding portion 5 is indicated by a two-dot chain line. This modification example is generally similar or identical to the embodiment described above. This modification example is different from the embodiment described above in that the step portion 6e is not formed by the shaft portion 8 and the side end portion 9. Hereinafter, the difference between the embodiment and the modification example will be mainly described.

The core portion 6 includes the exposed portion 7a and the non-exposed portion 7b as in the embodiment described above. The exposed portion 7a forms a part of the side surface 2c of the element body 2. The exposed portion 7a includes the wall surface 6a. The wall surface 6a is an exposed surface. In this modification example, the exposed portion 7a does not include the side surface 6b. The wall surface 6a is an exposed surface exposed from the resin molding portion 5. The wall surface 6a intersects the width direction D3. The wall surface 6a forms a part of the side surface 2c. The exposed portion 7a is formed by each side end portion 9.

In this modification example, the non-exposed portion 7b includes the side surface 6c and a side surface 6f. The non-exposed portion 7b does not include the wall surface 6d. The coil 4 is wound around the side surface 6c. The side surface 6c and the side surface 6f are continuous with each other and extend in the width direction D3. Each side end portion 9 includes the side surface 6f of the non-exposed portion 7b. The side surface 6c of the shaft portion 8 and the side surface 6f of the pair of side end portions 9 are flush with each other in the width direction D3. The side surface 6c corresponds to a first side surface, and the side surface 6f corresponds to a second side surface.

The side surface 6f of the non-exposed portion 7b is connected to the wall surface 6a of the exposed portion 7a. The core portion 6 does not include the step portion 6e. The projection area of the exposed portion 7a in the width direction D3 is equal to the projection area of the shaft portion 8 in the width direction D3. In other words, the edge of the shaft portion 8 overlaps the edge of the exposed portion 7a when viewed from the width direction D3. The core portion 6 is formed in a columnar shape extending in the width direction D3 by the shaft portion 8 and the pair of side end portions 9.

In this modification example, the pair of end surfaces 5a form the entire surface of the pair of end surfaces 2a. The pair of side surfaces 5b form the entire surface of the pair of side surfaces 2b. The resin molding portion 5 further includes a pair of side surfaces 5c. The pair of side surfaces 5c face each other in the width direction D3. Each side surface 5c forms a part of the side surface 2c of the element body 2. The side surface 2c is formed by the side surface 5c and the wall surface 6a. In other words, when viewed from the width direction D3, the wall surface 6a of the exposed portion 7a is surrounded by the side surface 5c formed by the resin molding portion 5. The side surface 5c of the resin molding portion 5 and the wall surface 6a of the core portion 6 are flush with each other. Each side surface 2c of the element body 2 is formed flat by the pair of side end portions 9 and the resin molding portion 5. Each end surface 2a and each side surface 2b of the element body 2 are formed only by the resin molding portion 5.

Next, the actions and effects of the coil components in the present embodiment and the modification example will be described. In the coil component 1 described above, the core portion 6 includes the pair of side end portions 9 and the shaft portion 8 which are integrally formed of the same material. The pair of side end portions 9 are continuous with both ends of the shaft portion 8 in the direction in which the shaft portion 8 extends. At least a part of the pair of side end portions 9 is exposed from the resin molding portion 5. In this case, the element body 2 is unlikely to be distorted, even if the core portion 6 thermally expands, the element body is unlikely to be distorted because the pair of side end portions 9 are exposed from the resin molding portion 5. Accordingly, a distortion of the element body 2 in response to a change in temperature can be suppressed.

The pair of side end portions 9 include the exposed portion 7a. The exposed portion 7a is exposed from the resin molding portion 5. When viewed from the width direction D3, the shaft portion 8 is positioned in the region where the exposed portion 7a is positioned. The projection area of the exposed portion 7a in the width direction D3 is larger than the projection area of the shaft portion 8 in the width direction D3. In this case, since the area of the exposed portion 7a in the core portion 6 is relatively larger, the distortion of the element body 2 in response to the temperature change can be further suppressed.

The pair of side end portions 9 form a step with respect to the shaft portion 8. In this case, the position of the coil 4 in the width direction D3 is regulated by the step. Accordingly, with this structure, variations between products can be reduced and an improvement in production throughput can be achieved.

When viewed from the width direction D3, the wall surface 6a of the exposed portion 7a is surrounded by the side surface 5c formed by the resin molding portion 5. In this case, the position of the shaft portion 8 around which the coil 4 is wound can be easily grasped from the position of the wall surface 6a. Accordingly, with this structure, visual inspection is facilitated and manufacturing cost reduction can be achieved.

The shaft portion 8 includes the side surface 6c extending in the width direction D3. Each of the pair of side end portions 9 includes the side surface 6f extending in the width direction D3. The side surface 6c of the shaft portion 8 and the side surface 6f of each side end portion 9 are flush with each other in the width direction D3. In this case, the position of the shaft portion 8 around which the coil 4 is wound can be easily grasped from the position of the exposed portion 7a. Accordingly, with this structure, visual inspection is facilitated and manufacturing cost reduction can be achieved.

The core portion 6 is formed of resin. In this case, the dielectric constant of the shaft portion 8 can be reduced as compared with a case where the shaft portion 8 is formed of ceramic. Accordingly, the coil component 1 is capable of adapting to a higher frequency.

The resin molding portion 5 and the core portion 6 are formed of mutually different materials. In this case, the dielectric constant of the core portion 6 can be reduced as compared with a case where the core portion 6 is formed of a ceramic material.

Although an embodiment and a modification example of the present invention have been described above, the present invention is not necessarily limited to the above embodiment and modification example. Various modifications can be made within the gist thereof.

For example, the shaft portion 8 may extend in the longitudinal direction D1, which is longer than the height direction D2 and the width direction D3, although the shaft portion 8 in the above embodiment and modification example extends in the width direction D3, which is shorter than the longitudinal direction D1.

1. A coil component comprising:
an element body;
a coil disposed in the element body and having a pair of tip portions; and
a pair of external electrodes disposed on an outer surface of the element body and respectively connected to the pair of tip portions, wherein
the element body includes a core portion around which the coil is wound and a resin molding portion covering at least a part of the core portion and covering at least a part of the coil,
the core portion includes a shaft portion extending in a first direction with the coil wound around the shaft portion and a pair of side end portions continuous with both ends of the shaft portion in the first direction,
the shaft portion and the pair of side end portions are integrally formed of the same material,
the shaft portion is covered with the resin molding portion, and
at least a part of the pair of side end portions is exposed from the resin molding portion.

2. The coil component according to claim 1, wherein
the pair of side end portions include an exposed portion exposed from the resin molding portion,
the shaft portion is positioned in a region where the exposed portion is positioned when viewed from the first direction, and
a projection area of the exposed portion in the first direction is larger than a projection area of the shaft portion in the first direction.

3. The coil component according to claim 1, wherein the pair of side end portions form a step with respect to the shaft portion.

4. The coil component according to claim 2, wherein the pair of side end portions form a step with respect to the shaft portion.

5. The coil component according to claim 1, wherein
the pair of side end portions include an exposed surface exposed from the resin molding portion, and
the exposed surface is surrounded by a surface formed by the resin molding portion when viewed from the first direction.

6. The coil component according to claim 1, wherein
the shaft portion includes a first side surface extending in the first direction,
each of the pair of side end portions includes a second side surface extending in the first direction, and
the first side surface and the second side surface of each of the side end portions are flush with each other in the first direction.

7. The coil component according to claim 5, wherein
the shaft portion includes a first side surface extending in the first direction,
each of the pair of side end portions includes a second side surface extending in the first direction, and
the first side surface and the second side surface of each of the side end portions are flush with each other in the first direction.

8. The coil component according to claim 1, wherein the core portion is formed of resin.

9. The coil component according to claim 1, wherein
the element body has at least one flat surface along the first direction, and
the pair of external electrodes are disposed on the resin molding portion on the same flat surface.

10. The coil component according to claim 1, wherein the resin molding portion and the core portion are formed of mutually different materials.
